(19) United States
(12) Patent Application Publication
(10) Pub. No.: US 2011/0270670 A1
(43) Pub. Date: Nov. 3, 2011

(54) METHOD AND SYSTEM FOR FACILITATING ONLINE ADVERTISING

(76) Inventor: Robert Arthur LEATHERN, Alameda, CA (US)

(21) Appl. No.: 12/772,480

(22) Filed: May 3, 2010

(51) Int. Cl. G06Q 30/00

(52) U.S. Cl. 705/14.41; 705/14.69

(57) ABSTRACT

This invention relates to a method of facilitating online advertising. The method includes the step of receiving a financial value, for example, a subscription, from at least one subscribing member, for example, an advertiser, of a system for facilitating online advertising for applying at least one advertising specific rule to advertisements provided on websites or web pages visited by users of the system. A further step involves measuring an amount of user activity on each of a plurality of websites visited by the users of the system by way of at least a client tracking module. A still further step involves allocating a portion of the received financial value to each website visited by the users of the system in proportion to the amount of user activity measured on each website. The invention also extends to an associated method and system.

### BACKGROUND OF THE INVENTION

THIS invention relates to a method and system for facilitating online advertising.

Given the wide and expanding reach of the Internet and especially the World Wide Web or “web” as a source of consumer information especially with regards to consumer products and services, advertisers have recognised the potential of the web as an effective and measurable medium for disseminating advertisements to the public.

One conventional advertising format on a web page is referred to as a “banner”, and is a web advertisement that takes the form of a graphical display situated at a visible location on a rendered web page. A banner for a given product or service typically implements a link to enable a consumer to “click-through” from the banner (via a mouse click on the banner) to transition, via his/her browser, to a website maintained by a corresponding advertiser and, from that site, fetch a web page to provide additional information regarding that product or service. Each display of a banner or other advertisement to a user is referred to as an “impression”, and advertisers typically compensate website owners based on either the number of impressions shown in aggregate, the number of impressions shown to specific classes of users, the number of click-throughs, a fixed payment amount, or a combination thereof. For brevity, “website” in the context of the specification will be also understood to include the website owners, publishers, or the like.

While the advertisements or impressions generate revenue for website owners, the display of the advertisements or impressions on requested websites often results in delays in the time in which the requested websites are downloaded to a user's computer. This may be due to the banners having graphic, video or audio content or the like associated therewith which causes delays in the download. Many advertisements or impressions are inappropriate for or are irrelevant to those users to which the advertisements or impressions are displayed. These and various other reasons result in users opting to implement or subscribe to services which may prevent banners or other forms of advertising from being shown on the websites which they request via their web browsers. This deprives websites of advertising revenue that would have been earned by displaying advertising to the users who access them.

Advertising revenue that websites earn is usually positively correlated with the ratio of click-throughs to banners or impressions over a period of time, and it is thus in the interest of websites to improve this ratio.

### SUMMARY OF THE INVENTION

According to a first aspect of the invention there is provided a method of facilitating online advertising, the method comprising:
receiving a financial value from at least one subscribing member of a system for facilitating online advertising for applying at least one advertising specific rule to advertisements provided on websites or web pages visited by users of the system;
measuring an amount of user activity on each of a plurality of websites visited by the users of the system by way of at least a client tracking module; and
allocating a portion of the received financial value to each website visited by the users of the system in proportion to the amount of user activity measured on each website.

The method may comprise receiving a financial value from a plurality of subscribing members, wherein the subscribing members include either users of the system and/or advertisers.

The method may comprise registering at least some of the subscribing members to the system, wherein the subscribing members further comprise owners or publishers of websites and/or companies/third parties.

The financial value received may comprise subscription fees from the subscribing members, typically the advertisers and some users.

The method may comprise paying or transferring the allocated portion of the received financial value to an owner or publisher of each website, or an associated company, or the like.

It will be appreciated that measuring the amount of activity on a website may comprise tracking the number or frequency of user visits to the website and/or the duration of the visits.

The method may further comprise using additional information to measure the amount of activity on a website, the additional information comprising information indicative of user ratings of a website and/or information relating to specific users.

The method may comprise:
providing advertisements to the user; and
determining or testing whether the user responds to the advertisements.

In this case, these advertisements may comprise a set of ads that would otherwise not have shown to the user. These advertisements may be conventional ads or any other type of ‘content’ that is contemplated in the specification, for example, a user survey, advertisements that the users previously saw that were stored and replayed for them at a later time, or novel advertisements they had not seen before for the “advertiser” or for any number of third-party entities or services.

Instead, or in addition, the method may comprise:
receiving information indicative of a user's interests or advertisement preferences; and
providing the user with advertisements which correspond substantially to the user's interests or advertisement preferences.

Instead, or in addition, the method may comprise:
monitoring the user's website visitation patterns;
determining which advertisements are potentially relevant or of interest to the user based on the monitored user's website visitation patterns; and
providing the potentially relevant advertisements to the user.

The method may also comprise applying at least one or a plurality of advertising specific rules to the advertisements provided to the user.

The rules may be one or more of not providing any advertisements to the user at all; displaying a specific category of advertisements to the user; displaying a certain number of advertisements at a certain frequency.

The method may comprise receiving an input from the user indicating which advertising rule/s they want to apply.

According to a second aspect of the invention, there is provided a system for facilitating online advertising, the system comprising:
a funds collection module operable to receive a financial value from at least one subscribing member of the system for applying at least one advertising specific rule to advertisements provided on websites or web pages visited by users of the system;
a client tracking module operable to measure an amount or degree of activity a website or web page experiences from a user of the system; and
an aggregation module arranged to allocate a portion of the financial value received from the user via the funds collection module to each website visited by the users of the system in proportion to the amount of activity measured by the client tracking module for each website.

The funds collection module may be configured to receive a financial value from a plurality of subscribing members, wherein the subscribing members include one or more of users of the system, advertisers, companies, and third parties

The system may comprise a page rendering module, the page rendering module may be configured to apply the at least one advertising specific rule to advertisements provided on websites or web pages visited by users of the system.

The page rendering module may preferably be configured to manipulate a website or webpage to display at least one particular advertisement in accordance with at least one advertising specific rule.

The client tracking module and page rendering module may be associated with at least one web browser which the user typically uses such that these modules are operated when the user is viewing pages on websites by way of the web browser.

The system may comprise a distribution module configured to transmit the client tracking module and/or the page rendering module to the user's end-point terminal or device, the client tracking module and the page rendering module may be configured to receive and/or transmit data from the user's end-point terminal or device.

The distribution module may be configured to transmit the client tracking module and/or the page rendering module to the user's end-point terminal or device in response to the user registering to use the system.

The system may comprise a visitation database arranged to store information indicative of the amount of activity associated with a particular website.

The system may comprise a configuration database arranged to store information required by the page rendering module and the client tracking module to perform their respective functions.

The system may further comprise a payments database configured to store account information for at least one member or user of the system, particularly the funds that have been paid or are due to be paid thereby.

The system may further comprise a payment module communicatively coupled to the payments database thereby to facilitate payment of the allocated portion of the received financial value to an owner or publisher of each website.

In an example embodiment, the system may further comprise:
a tracking server for storing at least one or more of data associated with any alterations or adjustments made to web pages by the page rendering module, data about user responses, or click-throughs; and
a page rendering server configured for storing data to be sent to each user.

According to a third aspect of the invention, there is provided a method of facilitating online advertising, the method comprising:
receiving a financial value from at least one subscribing member of a system for facilitating online advertising for applying at least one advertising specific rule to advertisements provided on websites or web pages visited by users of the system;
transmitting a client tracking module to the user's computer, the client tracking module being arranged to measure the amount of activity a website experiences from a user of the system;
receiving tracking information from the client tracking module indicative of the amount of activity on each of a plurality of websites visited by the users of the system; and
allocating a portion of the financial value received from the at least one subscribing member to each website visited by users of the system in proportion to the amount of activity measured for each website.

The method may further comprise transmitting a page rendering module to the user's computer, the page rendering module being arranged to apply the at least one advertising specific rule.

### BRIEF DESCRIPTION OF THE DRAWINGS

FIG. 1 shows a schematic diagram of a system in accordance with an example embodiment of the invention;

FIG. 2 shows a schematic diagram of part of the system of FIG. 1 in greater detail;

FIG. 3 shows a high level flow diagram of a method in accordance with an example embodiment;

FIG. 4 shows a flow diagram of a method in accordance with an example embodiment; and

FIG. 5 shows a flow diagram of another method in accordance with an example embodiment.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

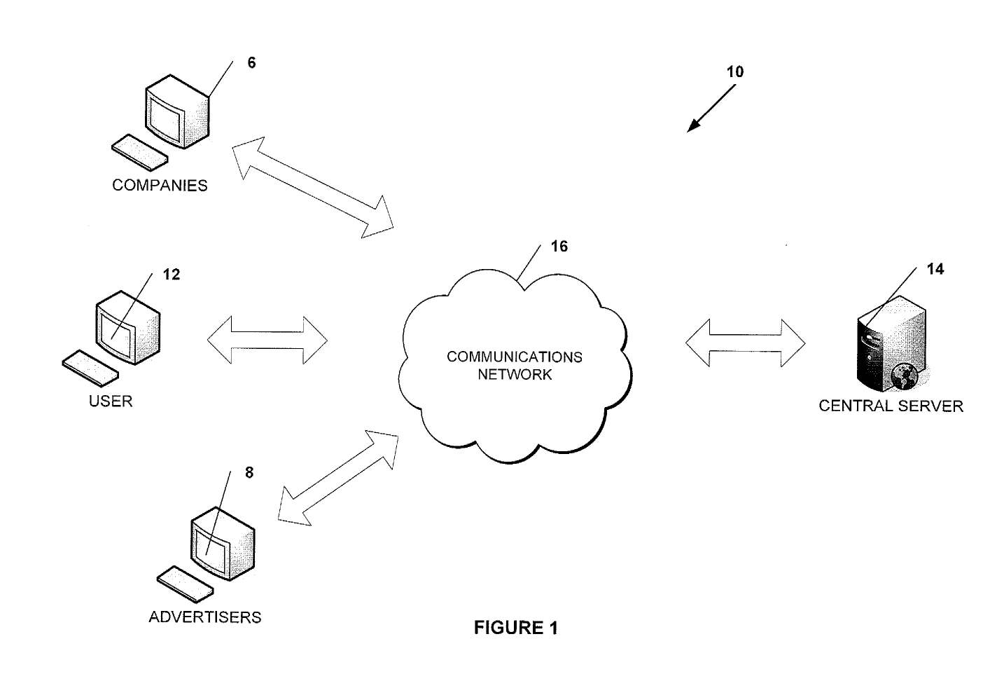

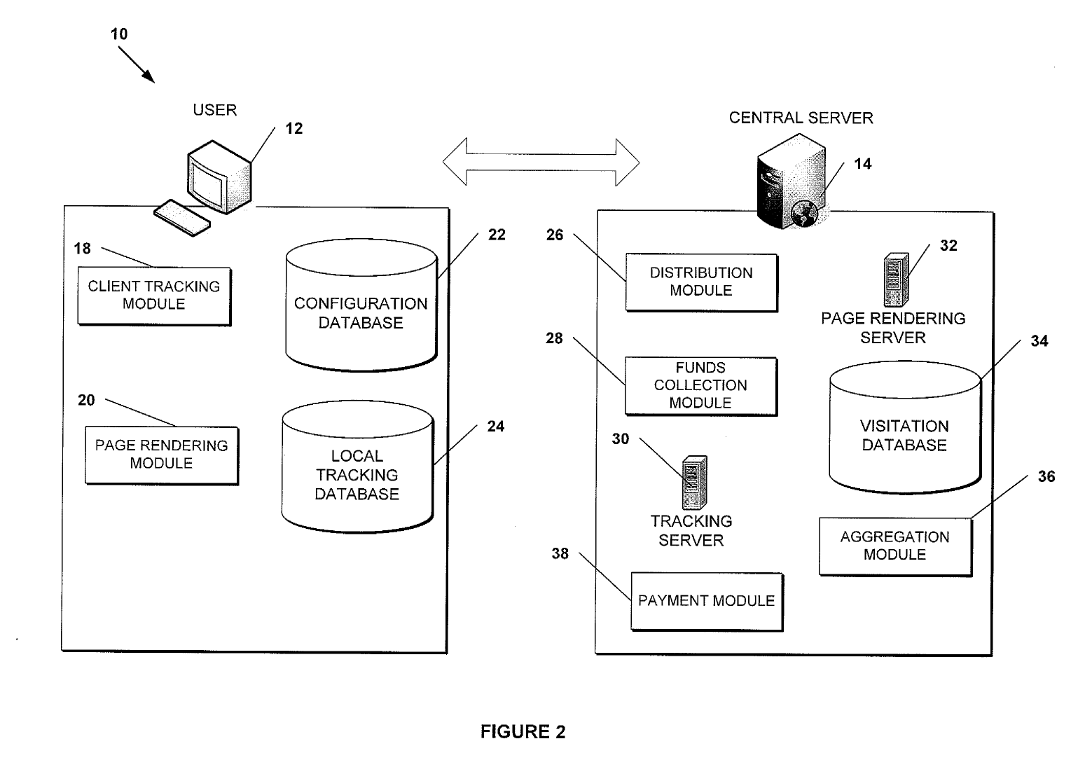

Referring to FIGS. 1 and 2 of the drawings a system in accordance with an example embodiment of the invention is generally indicated by reference numeral 10. The system 10 comprises a user 12 in communication with at least a central server 14 via a communications network 16 by way of an end-point terminal or device. In a preferred embodiment, the communications network 16 may be a packet-switched network and may form part of the Internet, a circuit switched network, a public switched data network, or any combination thereof, or the like.

For ease of description, the user 12 will be described with reference to their end-point terminal or device and vice versa. In any event, the end-point terminal or device may typically be a desktop computer, laptop computer, FDA (personal digital assistant), mobile telephone, or the like. The system 10 may comprise a plurality of users; however, only one user 12 is shown for ease of illustration.

The central server 14 may comprise an application or at least one device operable to communicate with at least the plurality of users 12 over the communications network 16.

The user 12 typically accesses the Internet and in particular websites on the World Wide Web via the communications network 16.

The system 10 further comprises advertisers 8 and companies 6. In an example embodiment, the companies 6 may include the companies which publish websites visited by the user 12. In other words the companies 6 may be the owners or publishers of the websites. The advertisers 8 may provide advertisements to users 12 by way of the websites. The companies 6 and the advertisers 8 may be operable to communicate with the central server 14 by way of the communication network 16.

The system 10 may comprise a plurality of components or modules which correspond to the functional tasks to be performed by the system 10. In this regard, “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware.

Further, the modules need not necessarily be consolidated into one device but may be spread across a plurality of devices. In other example embodiment, the modules may reside, be provided, or distributed within the network to provide their functionality within the system 10. In this regard, reference is now made in particular to FIG. 2 of the drawings where part of the system 10 is shown in greater detail (for ease of illustration, the companies 6, the advertisers 8, and the network 16 are not shown). The system 10 comprises a client tracking module 18 and a page rendering module 20 which are operatively installed (discussed below) and reside at the user 12. The client tracking module 18 is operable at least to measure the amount of activity on each of a plurality of websites visited by the user 12 whilst the page rendering module 20 is operable to apply at least one advertising specific rule to advertisements provided on websites or web pages visited by users 12.

As hereinbefore described, measuring the amount of activity on a website may comprise tracking the number or frequency of user 12 visits to the website, the duration of the visits, or the like. These may be weighted in a determined fashion to give a robust result as to the amount of activity on a website.

The system 10 is arranged to provide advertisements to the user 12; and to determine or test whether the user 12 responds to the advertisements.

In this case, these advertisements may be a set of ads that would be slot into the stream of ads that are replaced for the user 12 (all or some portion of the advertisements the user 12 would otherwise see would be replaced with new content/advertisements). These advertisements may be advertisements that would otherwise not have been shown to the user 12. These advertisements may be conventional ads or any other type of ‘content’ that is contemplated in the specification, for example, a user survey, advertisements that the users previously saw that were stored and replayed for them at a later time, or novel advertisements they had not seen before for the “advertiser” or for any number of third-party entities or services.

Instead, or in addition, the system 10 is configured to receive information indicative of a user's interests or advertisement preferences; and in response thereto provide the user with advertisements which correspond substantially to the user's interests or advertisement preferences.

Instead, or in addition, the system 10 is configured to monitor the user's website visitation patterns; determine which advertisements are potentially relevant or of interest to the user based on the website visitation patterns; and provide the potentially relevant advertisements to the user 12 as herein described.

The page rendering module 20 may be arranged to manipulate the website, the HTTP based web pages thereto in particular, as presented to the user 12 by applying the advertising specific rules thereto. The rules may include for example not displaying any advertisements to the user 12 at all, displaying a specific category of advertisements, for example advertisements related to sporting goods, displaying a certain number of advertisements at a certain frequency such as a single advertisement per day, or the like.

The client tracking module 18 and the page rendering module 20 may be associated with one or more web browsers which the user 12 typically uses to view websites. In this way, the modules 18, 20 may be operated or triggered to operate when the user 12 is viewing pages on websites.

The system 10 also comprises a distribution module 26 which may reside at the central server 14. The distribution module 26 may be operable to transmit the client tracking module 18 and the page rendering module 20 to the user 12. In an example embodiment, the distribution module 26 may include or form part of a distribution website accessible by the user 12. In this regard, the distribution module 26 need not necessarily reside at the central server 14. The distribution module 26 may be operable to register new users to use the system 10.

The system 10 further comprises a configuration database 22 located preferably at the user 12, the configuration database 22 being arranged to store information required by the page rendering module 20 and/or the client tracking module 18 for example the advertising specific rule to apply, website visitation patterns, or the like respectively. It will be understood that the configuration database 22 stores information which may potentially be relevant to the modules 18 and 20 for their respective operations.

The system 10 may comprise a local tracking database 24 at the user 12, the database 24 may be arranged to maintain and temporarily store information pertaining to the websites which the user 12 has visited. In an example embodiment the local tracking database 24 stores the information indicative of the amount of activity on each of a plurality of websites visited by the user 12 as measured by the client tracking module 18. The local tracking database 24 may temporarily store information before uploading the information to the central server 14.

The databases 22 and 24 may be provided as a single database for example in electronic storage means, for example, memory on the user endpoint device 12. However, for ease of explanation the databases 22 and 24 will be referred to a two separate components.

A funds collection module 28 may be provided at the central server 14 and may therefore be a server-based application module, the funds collection module 28 being operable to receive a financial value from at least one user 12 or advertisers 8. It will be appreciated that the funds collection module 28 may receive a financial value from companies or third parties which subsidize a particular user 12 i.e. for example, pay their subscription fee. In other example embodiments, the funds collection module 28 may only receive financial value from the advertisers 8 such that the advertisers subsidize the users 12.

The funds collection module 28 may be arranged to receive a financial value by way of a credit card transactions, stop order transaction, electronic transfer, cheque, or the like. In an example embodiment the funds collection module 28 may be operable to create an account for each user 12, advertiser 8, or the like. The funds collection database 28 may therefore include a database of accounts (not shown). The funds collection module 28 may be operable to debit an account of the user 12, in use. In an example embodiment, the funds collection module 28 may be accessible by way of an associated website, or the like.

A tracking server 30 may be provided at the central server 14 for storing data relating to the alterations or adjustments made to the web pages by the page rendering module 20, data about user 12 responses, click-throughs, or the like. It will be noted that a page rendering server 32 may also be provided at the central server 14, the page rendering server 32 may be arranged to store any files, pages or other data that are to be sent to each user 12 (explained in greater detail below).

The system 10, in particular the central server 14, further comprises a visitation database 34 of consumer visitation information. It will be appreciated that the consumer visitation information may include the information measured by the client tracking module 18. In particular the visitation database may include information indicative of which websites were visited by users 12 of the system 10, the frequency or number of visits to each site, the duration spent at each site, or the like.

It will be appreciated that in other example embodiments, a database of additional information (not shown) about web sites and individual consumers (additional information) may be provided. The additional information may be either collected directly from a website or imported from other external databases (explained in greater detail below).

In an example embodiment, the central server 14 includes an aggregation module 36 arranged to allocate a portion of the financial value received from the user 12 via the funds collection module 28 to each website visited by the users 12 of the system 10 proportionate to the amount of activity measured by at least the client tracking module 18 for each website. The activity is determined by the client tracking module 18.

It will be appreciated that the central server 14 may include a payments module 38 operable to create an account for at least each website, in particular each company 6 which publishes a website. The payments module 38 being operable to transfer the financial value calculated by the aggregation module 36 as hereinbefore described to the relevant account of the company 6. In an example embodiment, the payments module 38 includes a payments database (not shown) arranged to store and manage the accounts created by the payments module 38.

The payments module 38 may be accessible by companies 8 by way of an associated website, typically a publisher verification website that allows each account holder, for example the company 6, to confirm their identity and once confirmed, to access funds due to them.

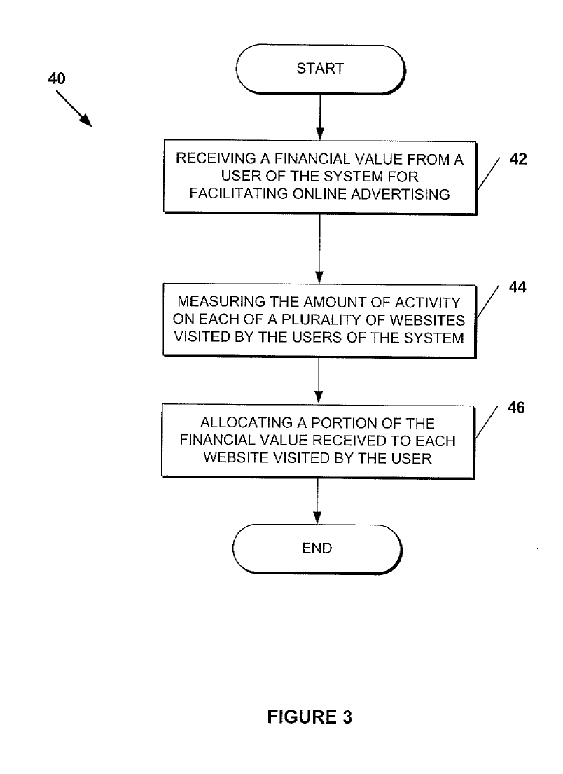

In use, referring in particular to FIG. 3 of the drawings, a flow diagram of a method of managing and providing information to a user is generally indicated by reference numeral 40. It will be noted that in one example embodiment, the flow diagram of the example method shown in FIG. 3 may be employed by the system 10 of FIGS. 1 and 2. However, the example methods may also be employed in other systems not described in this application.

The method 40 comprises receiving, at block 42, a financial value from the user 12 of the system 10 for applying at least one advertising specific rule to advertisements provided on websites or web pages visited by users 12 of the system 10. The financial value may be a subscription fee received by the funds collection module 28. The user 12 who pays this subscription fee may be referred to as a subscribing user 12. In other embodiments, the method may include receiving a financial value from only advertisers 8. It will be appreciated that the funds collection module 28 may also collect or receive financial value from advertisers 8, and even the third parties.

The method 40 further comprises measuring, at block 44, the amount of activity on each of a plurality of websites visited by the users 12. This may be done by way of the client tracking module 18 as hereinbefore described.

The method 40 then comprises allocating, at block 46, a portion of the financial value received from the user 12 and/or the advertisers 8 and/or third partied to each website visited by the users 12 of the system 10 proportionate to the amount of activity measured for each website. The aggregation module 36 as hereinbefore described may be operable to perform this step.

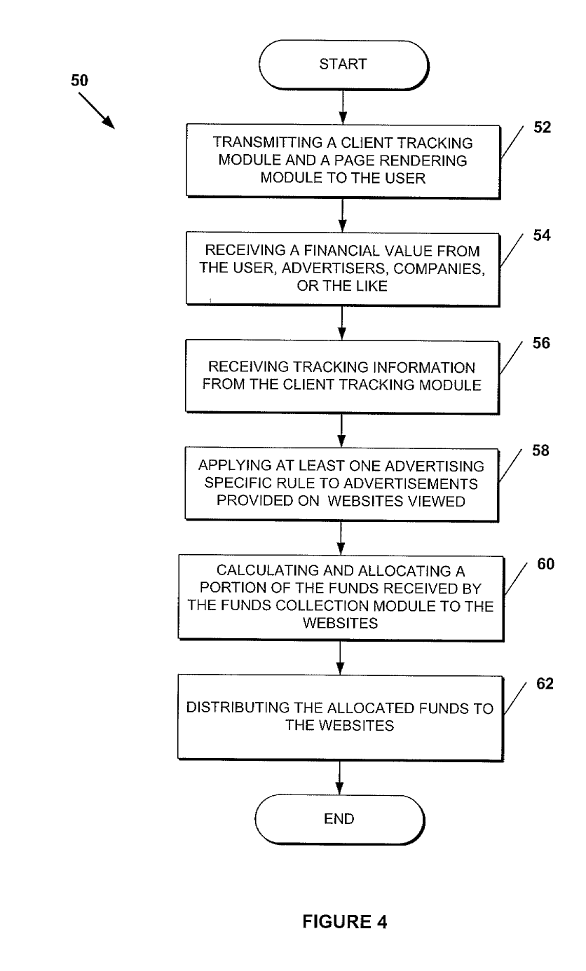

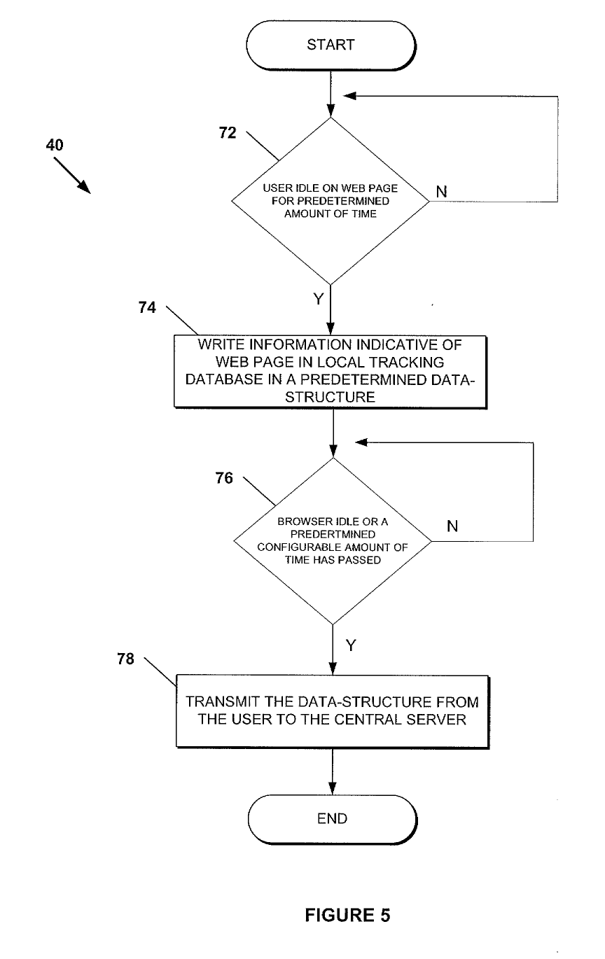

Reference is now made to FIGS. 4 and 5 of the drawings, where another method in accordance with an example embodiment is generally indicated by reference numeral 50. The method 50 comprises transmitting, at block 52, the client tracking module 18 and the page rendering module 20 to the user 12. In an example embodiment, the distribution module 26 may transmit the modules 18, 20 to the user 12 as soon as the user registers on the system 10 by way of the distribution module 26. A first-time user 12 accesses the distribution module 26 by visiting the distribution web site via his/her web browser and then registers himself/herself on the distribution website. In this regard, the distribution module 26 may therefore be arranged to receive personal identifying information about the user 12 such as his/her name, contact details, or the like at part of the registration.

The distribution module 26 allocates a unique identification code USER_IDENT to the user 12 thereby to identify the user 12 uniquely. The user 12 may also be given a selectable username, the username being associated with the USER_IDENT in the system 10 so as to identify the user 12. By registering the user 12, an account is created therefor in the funds collection module 28. In this regard, advertisers 8 may also have to undergo a registration process to create accounts in the funds collection module 28 therefor. When registering, users 12 may have to select a method of payment or payment choice to transfer a financial value, or subscription fee, to the funds collection module 28, particularly to their respective accounts in the funds collection module 28.

When registering the user 12, the distribution module 26 may present the user 12 with a list of advertising specific rules which the page rendering module 20 is operable to apply. The rules may specify the number, type, frequency, or the like of advertisements that the user 12 may opt to receive. The user 12 therefore gets an opportunity of selecting advertisements which are to be provided to him/her instead of receiving random and often irrelevant advertisements. In an example embodiment, a rule is provided which permits the user 12 to undertake certain actions for example, viewing a single advertisement every day, or completing a series of web-administered surveys instead of paying subscription fees to the funds collection module 28. It will be noted that records of all subscription fees paid by users 12 are recorded and are associated with their accounts within the funds collection module.

The method 50 then comprises receiving, at block 54, a financial value from at least a subscribing user 12 who has opted to transfer a financial value or subscription fee to the funds collection module 28. The step at block 54 may also include receiving a subscription fees from the advertisers 8 by way of the funds collection module 28. The account associated with each advertiser 8 may be accessed by the advertiser 8 physically, electronically, electronically via the Internet and a web browser, by another person or company that is authorised by, and acting on behalf of, the advertiser 8, or the like.

The method 50 may further comprise receiving, at block 56, tracking information from the client tracking module 18, the tracking information being indicative of the amount of activity on each of a plurality of websites visited by each user 12 in the system 10. In this regard, it will be noted that the client tracking module 18 interacts with the user's web browser in order to capture certain information about the user's web browsing activities, the HTTP requests that the user 12 makes as well as the pages, advertisements and other content that result from these HTTP requests.

When the user 12 operates their browser, the client tracking module 18 will attempt to contact the distribution website in particular the distribution module 26 via HTTP to check if there is any update necessary for the configuration database 22. If the connection is successful, and there is an update to be downloaded to the user 12, the client tracking module 18 is updated with the new values, for example, predetermined values such as times to be used by the user 12 downloaded by HTTP from the distribution module 26 to the configuration database 22. Once this update has been made, the client tracking module 18 will begin to track information about all of the websites which the user 12 views based on the updated data in the configuration database 22.

To explain the tracking and transmitting of information regarding activity on a website, we turn to FIG. 5 of the drawings where a method in accordance with an example embodiment for tracking and transmitting information regarding activity on a website is generally indicated by reference numeral 70. The method 70 comprises determining at block 72 the amount of time the user 12 is idle on a web page for example, not moving his/her mouse or typing anything via their keyboard on the web page. If the user 12 is idle for a predetermined configurable period of time, for example 120 seconds (which value is contained in the configuration database 22), the client tracking module 18 writes or records, at block 74, information indicative of the web page visit to the local tracking database 24. In an example embodiment, the following information may be recorded in a similar data-structure as indicated below, in the local tracking database 24 for each domain or web page visit:

DOMAIN: domain name
PARENT_DOMAIN: each HTTP document request and this may contain many other HTTP requests that compose it. For these sub-HTTP requests, the PARENT_DOMAIN contains the value of the main document request URL
TIME_START: local time (the user's 12) the domain visit began
TIME_END: local time (the user's 12) the domain visit ended
LAST_PAGE: full URL with all parameters that indicates the last page viewed on this domain before the user 12 either became idle, closed their browser or switched to a different visible tab on their browser (if the user 12 is utilizing a browser that has tabs available that allow them to browse across multiple sites simultaneously).

If, at block 76, the user's 12 web browser is idle for a predetermined amount of time or if a predetermined configurable period of time has elapsed, for example one hour since the last time that the information has been communicated from the user 12, the method 70 includes transmitting, at block 78, at least the data structure stored in the local tracking database 24, as described above, to the central server 14 and in particular the visitation database 34. The incremental domain visit information (that is, all the lines in the local tracking database 25 that have not yet been posted to the central server 14) is combined, serialized into a transferable format, and compressed for efficient transmission. It will be noted that the USER_IDENT is also transmitted with the data-structure such that the websites visited may be associated with the user.

To ensure anonymity, the USER_IDENT value is hashed based on a one-way hashing function to create a unique identifier before transmission to the central server 14. In this regard, it will be noted that the tracking server 30 receives the hashed value from the client tracking module 18 via an HTTP connection, and decodes it to determine the user 12, or at least his/her USER_IDENT.

The compressed data-structure that was sent via HTTP to the visitation database 34 is associated with the corresponding user 12 and the length of time that the user 12 spent on each domain is aggregated by way of the aggregation module 36. In an example embodiment, the visitation database 34 may send a success message via HTTP to the client tracking module 18, the latter then records that the transmitted data-structure has been successfully received thereby preventing a retransmission thereof.

Once received, at the visitation database 34, the files are decompressed and the data therein are added to database tables. Since the posting of information is based on periodic postings made at times not predicable a priori by the running instances of the client tracking module 18, a periodic summarisation process is run within the visitation database 34 in order to condense and normalise the visitation data therein. “Instances of the client tracking module” may be understood to each of the plurality of client tracking modules 18 corresponding to the different users of the system 10.

This summarisation process is executed periodically for example every hour (a frequency that is configurable at the central server 14 level) and it creates a database table (not shown) of all domains that have been communicated by the client tracking module 18 in the previous hour. This table is compared with a table of all unique domains that have been communicated by any instance of the client tracking module 18 i.e. all users 12 of the system 10 since the beginning of the system's 10 operation.

Any domains that were not previously encountered are added to a list of new domain accounts that are to be created. An account is thus created in the payments database (explained in greater detain below) for every new domain that is encountered, so that at all times there is an account for each unique domain that has been encountered. The amount of time that has been calculated for each domain visit, for each user 12 whose client tracking module 18 has sent such information, is stored in this database and associated with the account for that domain. The database record for each account also contains fields that will be completed at a later stage that specify the business name for the owner 6 of each domain, the address, phone number and other contact information for the domain owner 6, and an optional list of other domains which are also owned by the same domain owner 6.

In another example embodiment of the invention (not shown), an additional data-structure that exists within the account database is the publisher account. Publishers viz. website publishers 6 may create publisher accounts that contain one or more domain accounts, and which structure thereby allows them to aggregate their earnings across multiple domains but receive a single payment per period that adds together payments for all the individual domains under their control. Thus each domain account record is optionally associated with a publisher account record.

In an example embodiment, the data collected from each client tracking module 18 may be used to determine what the user's 12 interests are. This information may be useful when determining what advertisements may be relevant to the user.

The method 50 may comprise applying, at block 58, at least one advertising specific rule to advertisements provided on websites viewed by the user 12. Based on the USER_IDENT associated with the user 12 and therefore the client tracking module 18, the instance of the client tracking module 18 or a signature thereof containing the USER_IDENT can be uniquely identified by the tracking server 30 and rendering server 32 respectively. In this regard, based on data stored on the tracking server 30 for each user 12 of the system 10, a decision will be made about what advertising specific rules are to be applied to the web pages viewed by a particular user 12.

In an example embodiment, the replacement web pages and a file with the relevant advertising specific rules applied thereto will be stored on the page rendering server 32 and will then be pushed via HTTP to each user 12 who is meant to receive such rendered pages based on the information either stored on the page rendering server 32, or within the configuration database 22. For example, if the user 12 has selected an advertising specific rule which provides for the display of a single advertisement per day upon the initiation of their web browser, the page rendering module 20 will make an HTTP request, upon initiation of the browser, to the page rendering server 32 which will return a page and a set of files to be rendered by the user's browser. This formatted page may contain a link or links from which the user 12 may click-through to a set of pages that belong to an advertiser 8. The page rendering module 20 will reference both the configuration database 22 as well as DOMAIN and PARENT_DOMAIN data fields that are being captured by the client tracking module 18 to determine, as the user 12 is viewing the current page or at the current time, if any page enhancement should take place i.e. if any advertising specific rules should be applied.

If, for example, the advertising specific rules contained within the configuration database 22 specify that any pages or files coming from the domain XXXXX.COM should not be displayed, the page rendering module 20 will prevent the rendering of these pages or files. There may also be advertising specific rules stored in the configuration database 22 which may specify the replacement of a page or file of a certain pattern with another page or file, or the non-display of a page or pages with a specific domain pattern.

In other words, web site pages and advertisement banners originally requested by the user's 12 browser may be altered, and instead, an alternate set of web site pages viz. formatted pages and advertising banners will be rendered for the user 12 based on the rules in the configuration database 22 specific to that user 12 (identified via the USER_IDENT), based on the values captured by the client tracking module 18, and information requested by the page rendering module 20 pushed to the user 12 from the page rendering server 32.

It will be appreciated that based on the user 12 interactions with the formatted pages, especially those pages belonging to the advertiser 8, including the amount of time spent on the formatted page, click-throughs, responses to questions or interactive devices, and/or other interactions that the user has with the rendered formatted pages and/or the subsequent pages controlled by the advertiser 8, data will be sent from the browser, client tracking module 18 and page rendering module 20 to the tracking server 30 and associated with the account for that user 12. Depending on the user 12 response(s) or lack of response, decisions about the formatted pages which are subsequently sent to and rendered for the user 12 may be altered in order to improve the likelihood of response to, and interaction by the user 12 with, future formatted pages which they view on.

Aside, in an example embodiment, as briefly mentioned, above, the database of additional information (not shown) about web sites and individual users 12 or consumers may be maintained, typically at the central server. This additional information has either been collected directly from users 12 or third party companies by soliciting their input on a web site, or the data is imported from other external databases. All additional information within the database that can be associated with a particular domain name or website is stored in a particular table within the database that stores domain name-value pairs, and also stores a translation formula for each domain name-value pair. The translation formula specifies how the domain-level information affects the calculations of funds for domains and publishers. “Funds” in this regard refer to the financial value or subscription fees received by way of the funds collection module 28.

By way of illustration, the name-value pair might have been input by a user 12 or a consumer and may consist of a rating of 0 to 5 for a list of website domains. The translation formula might specify an extra percentage point weighting for each rating point, for each domain that is rated by a particular user 12 or consumer. So if XYZDOMAIN.COM were to have a rating of 3, and ABCDOMAIN.COM were to have a rating of 0, the relative weight of XYZDOMAIN.COM would increase by 3% and that of ABCDOMAIN.COM would remain unchanged. Thus when funds distributions are to be calculated, XYZDOMAIN.COM would increase its share of the aggregate funds contributed by the specific user 12 which rated these sites. In this way, additional subjective or objective factors may be taken into account that will affect the distribution of funds for sites visited by users 12 (explained in greater detail below). It will be noted that this database (not shown) may remain empty, or the additionally, information therein may not be used depending on a global setting across all users 12, or a user-specific setting which may disable it for a specific user 12 or group of users 12.

The method 50 of FIG. 4 may further comprise, calculating and allocating, at block 60, a portion funds received by the funds collection module 28, as hereinbefore described with reference block 54 of method 50, to websites visited by the users 12. This calculating and allocating may be performed by the aggregation module 36, typically on a daily, weekly, or monthly basis. During the calculation, additional information, in any, from the database of additional information is combined with aggregated visitation information across all the users 12 that are using the system 10 for the current time period. Aggregation calculations occur where all previously collected funds collected by the funds collection module 28 are analysed on a period-by-period basis, and the current period pro-rata portion is determined, namely:

a) all the funds that have been contributed by individual users 12, pro-rated for the length of the current period,
b) all funds that have been contributed by advertisers 8 or other entities on behalf of users 12 (third parties), or as a result of showing advertisements to certain users 12, pro-rated for the length of the current period in relation to the length of any contract that the advertiser 8 may have entered into, and/or funds are pro-rated based on certain performance metrics that have been recorded by the tracking server 30, for example the number of advertising page views (or “impressions”) actually shown to specific users 12 during the period.

By way of example, the following charts show this calculation and allocation as described above for a hypothetical set of users 12, namely 76112, 76128 and 76199; who visit a hypothetical set of web site domains numbered Domain1.com through Domain8.com. There are advertisers 8 named 802, 804 and 811 who have paid various amounts to target one or more of the aforementioned users 12. The users 12 have also paid varying amounts initially, some of which funds have already been accounted for and distributed in previous periods, and some of which will remain to be accounted for in future periods. Here the funds due to each domain for the current period are calculated.

### Example 1

### Aggregate User Visitation Data by User, Combined with Markup Data

| User | Domain | Visits | Time | Share | Markup | Net |
|---|---|---|---|---|---|---|
| 76112 | Domain1.com | 3 | 5:00:01 | 61% | 0% | 53% |
| | Domain2.com | 2 | 2:01:01 | 25% | 2% | 27% |
| | Domain3.com | 1 | 0:02:01 | 0% | 0% | 0% |
| | Domain4.com | 1 | 0:04:22 | 1% | 0% | 1% |
| | Domain5.com | 5 | 1:01:14 | 13% | 7% | 20% |
| 76128 | Domain3.com | 3 | 0:44:03 | 24% | 0% | 24% |
| | Domain4.com | 2 | 1:01:14 | 33% | 0% | 33% |
| | Domain5.com | 1 | 0:02:33 | 1% | 0% | 1% |
| | Domain6.com | 1 | 0:02:03 | 1% | 0% | 1% |
| | Domain7.com | 6 | 1:15:43 | 41% | 0% | 41% |
| 76199 | Domain1.com | 6 | 3:13:01 | 97% | 0% | 97% |
| | Domain5.com | 1 | 0:03:02 | 2% | 0% | 2% |
| | Domain8.com | 1 | 0:03:08 | 2% | 0% | 2% |

For each user 12, for each domain, there is data on the number of visits made by that user 12 to that domain, the aggregate time spent viewing pages on that website domain, the gross share of user 12 online time spent on that domain, the markup to the share data and the resulting net share that is used for the calculation of domain funds distribution. The markup data is a gross percentage markup that has been calculated based on additional information collected (as hereinbefore described). The net share percentages have been adjusted based on the markup being applied to the specific domains specified. These domains (Domain2.com and Domain5.com) have thus been given an additional benefit and will receive a more-than-proportional share of user funds.

### Example 2

### Payments Made by Users with Current Period Payment and Residuals

| User | Payment | Past | Left | Left Amt | Next Pay | Residual |
|---|---|---|---|---|---|---|
| 76112 | $60 | 4 | 8 | $40.00 | $5.00 | $1.00 |
| 76128 | $10 | 0 | 1 | $10.00 | $10.00 | $2.00 |
| 76199 | $30 | 6 | 6 | $15.00 | $2.50 | $0.50 |

For each user 12, the total payment previously made by the user 12 and collected by the funds collection module 28 is indicated. The previous number of periods (if the current calculation period is a month, such as this example, these periods will then refer to a month) across which the payment is to be applied is shown as is the number of periods remaining to which the “Left Amt” or remaining un-attributed funds are to be applied. Next Pay indicates the payment amount that is to be applied to the current period, and Residual indicates the amount of the original payment that is being collected in the current period as a fee for the system administrator or provider of the system 10. In this example, a total of $17.50 is to be allocated in aggregate to the various domain accounts, with an additional $3.50 to be set aside in a residual/fee system administrator or provider of the system 10.

### Example 3

### Payments Made by Advertisers for User Advertisements Completed in the Current Period

| Advertiser | Net Amount | Users | Fees | Paid |
|---|---|---|---|---|
| 802 | $7 | 76112 | $0.78 | $7.78 |
| 804 | $105 | 76112, 76128, 76199 | $11.67 | $116.67 |
| 811 | $60 | 76199 | $6.67 | $66.67 |

This chart aggregated funds paid in by advertisers 8. Each advertiser 8 shown here has made a payment or has made a promise of a payment (as determined by the funds collection module 28) during the period, based on some consumer behavior, advertising impression or other action that has triggered said payment to be due and payable this period. Each payment is allocated to one or more users 12, and the funds will be split between the various domains that that user has visited as indicated in Example 1 above. In addition, the fees/residual amounts are indicated for each advertiser 8 payment that are to be paid to the system administrator or provider of the system 10.

### Example 4

### User and Advertiser Calculation of Share by Domain

| User | Domain | User Share | Ad share |
|---|---|---|---|
| 76112 | Domain1.com | $2.63 | $3.68 |
| | Domain2.com | $1.34 | $1.87 |
| | Domain3.com | $0.02 | $0.02 |
| | Domain4.com | $0.04 | $0.05 |
| | Domain5.com | $0.98 | $1.37 |
| 76128 | Domain3.com | $2.37 | $24.92 |
| | Domain4.com | $3.30 | $34.64 |
| | Domain5.com | $0.14 | $1.44 |
| | Domain6.com | $0.11 | $1.16 |
| | Domain7.com | $4.08 | $42.84 |
| 76199 | Domain1.com | $2.42 | $58.14 |
| | Domain5.com | $0.04 | $0.91 |
| | Domain8.com | $0.04 | $0.94 |

Based on the visitation information, funds from the user 12 payments and the advertiser 8 payments (as indicated in Examples 2 and 3, above) are split on a user-by-user basis across the various domains. Indicated in the example are the amounts payable to each domain which a user 12 has visited. Note that in this example, the same net share percentage after markup has been applied to the user 12 funds as well as the advertiser 8 funds (shown in the user share and ad share columns), but that the system 10 can be used in such a way as to not apply a markup (if one exists) to the user 12 funds component, or to not apply a markup (if one exists) to the advertiser 8 funds component.

### Example 5

### Aggregated Funds Due by Domain

| Domain | Users | Advertisers | Total |
|---|---|---|---|
| Domain1.com | $5.05 | $61.82 | $66.88 |
| Domain2.com | $1.34 | $1.87 | $3.21 |
| Domain3.com | $2.39 | $24.95 | $27.34 |
| Domain4.com | $3.34 | $34.70 | $38.03 |
| Domain5.com | $1.15 | $3.72 | $4.88 |
| Domain6.com | $0.11 | $1.16 | $1.27 |
| Domain7.com | $4.08 | $42.84 | $46.91 |
| Domain8.com | $0.04 | $0.94 | $0.98 |
| Net due to pubs | $17.50 | $172.00 | $189.50 |
| Residual/fees | $3.50 | $19.11 | $22.61 |
| Grand total | $21.00 | $191.11 | $212.11 |

Data from all users 12 is compared and net amounts are calculated that are due to the owner 6 of each domain. The total of the user-based funds and advertiser-based funds is shown in the total column above. Residual fees are payable to the system administrator or provider of the system 10.

Lastly, the method 50 comprises distributing the allocated aggregated funds to the websites visited by the users 12, in particular the website publishers or companies 6 who own or operate the website domains that users 12 have visited during the period, and a residual amount is retained as a fee for a system provider or administrator (not shown) of the system 10. It will be noted that all the payments that are due to the companies or website or domain publishers 6 are stored in an associated account therefor in the payments database as described briefly above.

It will be appreciated that a publisher 6 may be defined as the owner of one or more domains, however, the ownership of each domain must be established. In this regard, in an example embodiment of the invention (not shown) the system 10 may include a publisher verification module (not shown) arranged to verify the identity of a publisher of a particular domain. The publisher verification module may include or form part of a publisher verification website where a publisher 6 must verify his/her identity before he/she can undergo payment registration thereby to access his/her payment account in the payment database of the payment module 38. Once they have undergone payment registration and verified their control over one or more domains, the publisher 6 will be able to receive the funds that are recorded in the payments database.

If the publisher 6 verifies the ownership of more than one domain, they will have the option of combining the payments due to the individual domains into a single payment, disbursed via this publisher account. The online verification for the domain owner/publisher 6 may comprise registering a domain owner/publisher 6 by way of the publisher verification module and creating a new account for the publisher 6, the account containing their personal details, for example their personal name, company name, address, telephone number, email address and other identifying information; receiving information indicative of the domain or domains which a publisher 6 owns; for each domain that is claimed, generating a unique filename and presenting the same to the domain owner 6 (the domain owner 6 has to create a file by that name on the domain which they are claiming ownership over); uploading a file by that same name from the publisher verification website to the domain in question; and, if the file is successfully referenced on the domain, informing the domain owner 6 that the process has been successful, and allowing the domain owner 6 to proceed to the next step and view the funds that are available in the payments database.

Upon successful publisher verification, the domain owner's 6 account is set to “validated” and he/she is then able to return to the site and as long as he/she logs in and provides the correct credentials that he/she established when setting up his/her account, he/she may withdraw the funds due to the domains under his/her control for the current period, or for future periods using the same credentials once the payment calculations have been made and funds become available for those future periods.

Validated web domain owners (publishers) 6 may visit the publisher verification page as described above and login using the credentials they have created. Once they login, they will be able to choose from several options for receiving the funds that are due to them. They may select from several payment options that may include a physical cheque, an electronic funds transfer (EFT), PayPal (a service of eBay, Inc. of San Jose, Calif.), or the like. The web site may also maintain information about past payments received, aggregate payments received, and any tax-related information as required by local law.

The inventor believes that the invention as hereinbefore described will alleviate some of the revenue loss experienced by website owners or publishers as a result of advertising being removed from their websites.

The inventor also believes that the invention will alleviate at least some of the nuisance users experience when bombarded by advertisements which do not necessarily interest them when requesting a website or webpage.

Also, by controlling the number of, timing, type, or the like, of advertisements received, a user has more degree of control of information presented to him/her.

The inventor also believes that the present invention provides advertisers with a means to reach those target customers who actually want to see their advertisements and are therefore at least interested in their goods or services. In other words, instead of paying a plurality of websites to advertise thereon and reaching a group of potential customers, only a few of whom may be interested in the advertiser's goods or services, the advertisers are paying to get their advertisements to only those potential customers who choose to receive them and who are therefore interested in the advertisers' goods or services.

1. A method of facilitating online advertising, the method comprising:
receiving a financial value from at least one subscribing member of a system for facilitating online advertising for applying at least one advertising specific rule to advertisements provided on websites or web pages visited by users of the system;
measuring an amount of user activity on each of a plurality of websites visited by the users of the system by way of at least a client tracking module; and
allocating a portion of the received financial value to each website visited by the users of the system in proportion to the amount of user activity measured on each website.

2. The method as claimed in claim 1, wherein the method comprises receiving a financial value from a plurality of subscribing members, wherein the subscribing members include either users of the system and/or advertisers.

3. The method as claimed in claim 2, wherein the method comprises registering at least some of the subscribing members to the system, wherein the subscribing members further comprise owners or publishers of websites and/or companies/third parties.

4. The method as claimed in claim 1, wherein the financial value received comprises subscription fees from the subscribing members.

5. The method as claimed in claim 1, wherein the method comprises paying or transferring the allocated portion of the received financial value to an owner or publisher of each website.

6. The method as claimed in claim 1, wherein measuring the amount of activity on a website comprises tracking the number or frequency of user visits to the website and/or the duration of the visits.

7. The method as claimed in claim 1, wherein the method further comprises using additional information to measure the amount of activity on a website, the additional information comprising information indicative of user ratings of a website and/or information relating to specific users.

8. The method as claimed in any one of claims 1 to 7, wherein the method comprises:
providing advertisements to the user; and
determining or testing whether the user responds to the advertisements.

9. The method as claimed in any one of claims 1 to 7, wherein the method comprises:
receiving information indicative of a user's interests or advertisement preferences; and
providing the user with advertisements which correspond substantially to the user's interests or advertisement preferences.

10. The method as claimed in any one of claims 1 to 7, wherein the method comprises:
monitoring the user's website visitation patterns;
determining which advertisements are potentially relevant or of interest to the user based on the monitored user's website visitation patterns; and
providing the potentially relevant advertisements to the user.

11. The method as claimed in claim 10, wherein the method comprises applying at least one or a plurality of advertising specific rules to the advertisements provided to the user.

12. The method as claimed in claim 11, wherein the rules are one or more of not providing any advertisements to the user at all; displaying a specific category of advertisements to the user; displaying a certain number of advertisements at a certain frequency.

13. The method as claimed in claim 11, wherein the method comprises receiving an input from the user indicative of the advertising rule/s which the user desired to be applied.

14. A system for facilitating online advertising, the system comprising:
a funds collection module operable to receive a financial value from at least one subscribing member of the system for applying at least one advertising specific rule to advertisements provided on websites or web pages visited by users of the system;
a client tracking module operable to measure an amount or degree of activity a website or web page experiences from a user of the system; and
an aggregation module arranged to allocate a portion of the financial value received from the user via the funds collection module to each website visited by the users of the system in proportion to the amount of activity measured by the client tracking module for each website.

15. The system as claimed in claim 14, wherein the funds collection module is configured to receive a financial value from a plurality of subscribing members, wherein the subscribing members include one or more of users of the system, advertisers, companies, and third parties

16. The system as claimed in claim 14, wherein the system comprises a page rendering module, the page rendering module being configured to apply the at least one advertising specific rule to advertisements provided on websites or web pages visited by users of the system.

17. The system as claimed in claim 16, wherein the page rendering module is configured to manipulate a website or webpage to display at least one particular advertisement in accordance with at least one advertising specific rule.

18. The system as claimed in claim 16, wherein the client tracking module and page rendering module is associated with at least one web browser which the user typically uses such that these modules are operated when the user is viewing pages on websites by way of the web browser.

19. The system as claimed in claim 16, wherein the system comprises a distribution module configured to transmit the client tracking module and/or the page rendering module to the user's end-point terminal or device, the client tracking module and the page rendering module being configured to receive and/or transmit data from the user's end-point terminal or device.

20. The system as claimed in claim 19, wherein the distribution module is configured to transmit the client tracking module and/or the page rendering module to the user's end-point terminal or device in response to the user registering to use the system.

21. The system as claimed in claim 14, wherein the system comprises a visitation database arranged to store information indicative of the amount of activity associated with a particular website.

22. The system as claimed in claim 16, wherein the system comprises a configuration database arranged to store information required by the page rendering module and the client tracking module to perform their respective functions.

23. The system as claimed in claim 14, wherein the system further comprises a payments database configured to store account information for at least one member or user of the system, particularly the funds that have been paid or are due to be paid thereby.

24. The system as claimed in claim 23, wherein the system further comprises a payment module communicatively coupled to the payments database thereby to facilitate payment of the allocated portion of the received financial value to an owner or publisher of each website.

25. The system as claimed in claim 16, wherein the system further comprises:
a tracking server for storing at least one or more of data associated with any alterations or adjustments made to web pages by the page rendering module, data about user responses, or click-throughs; and
a page rendering server configured for storing data to be sent to each user.

26. A method of facilitating online advertising, the method comprising:
receiving a financial value from at least one subscribing member of a system for facilitating online advertising for applying at least one advertising specific rule to advertisements provided on websites or web pages visited by users of the system;
transmitting a client tracking module to the user's computer, the client tracking module being arranged to measure the amount of activity a website experiences from a user of the system;
receiving tracking information from the client tracking module indicative of the amount of activity on each of a plurality of websites visited by the users of the system; and
allocating a portion of the financial value received from the at least one subscribing member to each website visited by users of the system in proportion to the amount of activity measured for each website.

27. The method as claimed in claim 26, wherein the method further comprises transmitting a page rendering module to the user's computer, the page rendering module being arranged to apply the at least one advertising specific rule.
